(19) United States
(12) Patent Application Publication
(10) Pub. No.: US 2014/0054988 A1
(43) Pub. Date: Feb. 27, 2014

(54) HYBRID MOTOR VEHICLE DEVICE

(71) Applicant: DAIMLER AG, Stuttgart (DE)

(72) Inventor: Claus Hofmaier, Stuttgart (DE)

(73) Assignee: DAIMLER AG, Stuttgart (DE)

(21) Appl. No.: 14/027,207

(22) Filed: Sep. 15, 2013

Related U.S. Application Data
(63) Continuation-in-part of application No. PCT/EP2011/006071, filed on Dec. 3, 2011.

(30) Foreign Application Priority Data
Mar. 29, 2011 (DE) 10 2011 015 376.4

(51) Int. Cl. H02K 9/19

(52) U.S. Cl. CPC H02K 9/19
USPC 310/54

(57) ABSTRACT

In a hybrid motor vehicle device, comprising an internal combustion engine, a transmission unit connected to the internal combustion engine and including at least one electric motor which is provided for connection to the transmission unit, a starting element connected to the engine, an operating medium pressure system is provided for cooling the electric motor and the starting element, with a cooling duct, which, in at least one operating state, places the starting element and the electric motor in fluid communication with one another, the operating medium pressure system having at least one adjustment unit for varying a flow cross section of the cooling duct for controlling the coolant flow to the electric motor in the at least one operating state.

This is a Continuation-In-Part Application of pending international patent application PCT/EP2011/006071 filed Dec. 03, 2011 and claiming the priority of German patent application 10 2011 015 376.4 filed Mar. 29, 2011.

### BACKGROUND OF THE INVENTION

The invention relates to a hybrid motor vehicle device having a starting element for connecting an internal combustion engine to a transmission and an electric motor which can be connected to the internal combustion engine via the starting element.

A hybrid motor vehicle device is known from DE 10 2005 040 771 A1, having a starting element which is provided for connecting an internal combustion engine to a transmission unit, having an electric motor which is provided for connecting to the transmission unit, having an operating medium pressure system which is provided for at least cooling the electric motor and the starting element, and having at least one cooling duct which connects the starting element and the electric motor to one another in terms of flow.

It is the principal object of the present invention to provide a hybrid motor vehicle device in which cooling of the electric motor is provided for as needed.

### SUMMARY OF THE INVENTION

In a hybrid motor vehicle device, comprising an internal combustion engine, a transmission unit connected to the internal combustion engine and including at least one electric motor for connection to the transmission unit, a starting element is connected to the engine which includes an operating medium pressure system for at least cooling the electric motor and the starting element, via at least one cooling duct, which, in at least one operating state, places the starting element and the electric motor in fluid communication with one another, the operating medium pressure system having at least one adjustment unit for varying a flow cross section of the cooling duct for controlling the coolant flow to the electric motor in the at least one operating state.

It is proposed that the operating medium pressure system has at least one adjustment unit varying a flow cross section of the cooling duct. A flow rate of coolant for the electric motor may thus be varied as needed, so that a hybrid motor vehicle device may be provided which ensures cooling of the electric motor as needed. Due to the cooling of the electric motor as needed, a defined quantity of coolant for the electric motor, in particular during travel of a hybrid motor vehicle while the hybrid motor vehicle device uses solely the electric motor, may be adjusted, so that the electric motor may be supplied with coolant as needed. An operating medium leak, in particular during travel of the hybrid motor vehicle using solely the internal combustion engine, may thus be reduced, so that the efficiency and operating medium economy may be improved. A “starting element” is understood in particular to mean a component which is situated in a power flow between an internal combustion engine and a transmission unit, and which has a primary side and a secondary side which may be separated or joined together, and which are provided for ensuring a slipping transmission of force between the internal combustion engine and the transmission unit for jerk-free starting of a motor vehicle. The starting element is preferably designed as a starting clutch situated upstream from the transmission unit, a starting clutch integrated into the transmission unit, and/or a torque converter, A “primary side” is understood in particular to mean a side of the starting element which is provided for the rotationally fixed connection to the internal combustion engine, in particular to an internal combustion engine output shaft, and/or which is decoupleable from the transmission unit. A “secondary side” is understood in particular to mean a side of the starting element which is provided for the rotationally fixed connection to the transmission unit, in particular to a transmission input shaft, and/or which is decoupleable from the internal combustion engine. A “cooling duct” is understood in particular to mean a flow connection between at least two operating medium chambers and/or between at least two elements. A “flow cross section” is understood in particular to mean a cross section which may be used by the operating medium to flow from one operating medium chamber into another operating medium chamber. The term “as needed” is understood in particular to mean that supplying with operating medium, in particular coolant, is adjusted as a function of a need for this operating medium, in particular coolant, by an element which is to be cooled. The term “element to be cooled” means an element of the starting element and/or of the electric motor, from which heat is withdrawn in particular during operation, thus cooling the element, in particular to prevent a defect, destruction, and/or functional impairment of the electric motor and/or the starting element. For example, the element of the electric motor to be cooled may be designed as an operating head. The term “travel using solely the electric motor” is understood in particular to mean a drive mode of the hybrid motor vehicle in which solely the one electric motor delivers a torque for driving the hybrid motor vehicle. The term “travel using solely the internal combustion engine” is understood in particular to mean a drive mode of the hybrid motor vehicle in which solely the at least one internal combustion engine delivers a torque for driving the hybrid motor vehicle. “Hybrid motor vehicle” is understood in particular to mean a motor vehicle having at least one electric motor and at least one internal combustion engine, wherein the at least one electric motor and the at least one internal combustion engine, either individually or in combination, drive final drive elements such as drive wheels. The term “provided” is understood in particular to mean specially programmed, designed, equipped, and/or situated.

The adjustment unit is preferably also provided for varying the flow cross section of the cooling duct as a function of an operating state of the internal combustion engine, in particular, either directly or indirectly by means of the operating state of the starting element.

In one advantageous embodiment, the adjustment unit has at least one blocking element which is provided for closing the cooling duct in an activated state of the starting element, and for opening the cooling duct in an unactivated state of the starting element, Cooling of the starting element and of the electric motor as needed may thus be implemented in a particularly simple manner. “Activated state” is understood in particular to mean an activation state of the starting element in which the starting element is provided for transmitting torque between the internal combustion engine and the transmission unit, and/or in which the starting element couples the internal combustion engine and the transmission unit, and thus the primary side and the secondary side, to one another in terms of action. “Unactivated state” is understood in particular to mean an activation state of the starting element in which the starting element is provided for preventing a transmission of torque between the internal combustion engine and the transmission unit, and/or in which the starting element decouples the internal combustion engine and the transmission unit, and thus the primary side and the secondary side, from one another.

It is further proposed that the blocking element is provided for varying the flow cross section of the cooling duct as a function of a centrifugal force in the starting element. A dependency on the operating state of the starting element may thus be provided in a particularly simple manner. “Centrifugal force” is understood in particular to mean a force caused by a rotation of at least one component of the starting element, in particular of the primary side of the starting element, and which thus has a dependency on the rotational speed of the at least one component of the starting element.

It is further proposed that the blocking element is provided for varying the flow cross section of the cooling duct as a function of an operating medium pressure in the starting element. A particularly advantageous dependency, which is alternatively or additionally usable, on the operating state of the starting element may thus be provided. “Operating medium pressure” is understood in particular to mean a pressure of the operating medium in an operating medium chamber, in particular of the starting element, which in particular is provided as an activation pressure, a cooling pressure, and/or a lubrication pressure. “Activation pressure” is understood in particular to mean an operating medium pressure which is used for activating at least one component of the starting element, in particular the primary side, and/or which is used for transmitting torque in the starting element and/or which prevails in an activation medium chamber of the starting element. “Cooling pressure” is understood in particular to mean an operating medium pressure which is used for cooling at least one component and/or which prevails in a coolant chamber. “Lubrication pressure” is understood in particular to mean an operating medium pressure which is used for lubricating at least one component and/or which prevails in a lubricant chamber.

In particular, it is advantageous for the blocking element to be designed as a valve piston. A particularly advantageous blocking element may thus be provided. “Valve piston” is understood in particular to mean a piston which is situated so as to be movable, in particular in two opposite directions, in an element or body which at least partially surrounds same.

In addition, it is advantageous for the adjustment unit to have at least one restoring element which is provided for automatically opening the cooling duct as a function of at least one force in the starting element. An automatic, independent switching over between supplying the electric motor with coolant and supplying the starting element with coolant may thus be implemented, so that in particular the cooling of the electric motor and of the starting element between the travel using solely the electric motor and the travel using solely the internal combustion engine may be implemented. “Automatically” is understood in particular to mean independently of electrical control and/or regulation.

The restoring element particularly preferably has at least one control pressure duct. Automatic opening of the cooling duct as a function of an operating medium pressure, in particular a cooling pressure, may thus be implemented.

In another embodiment according to the invention, it is proposed that the cooling duct is designed as a coolant supply duct which is provided for conducting a coolant from an operating medium chamber of the starting element into the electric motor. A particularly advantageous operating medium pressure system may thus be provided.

In addition, it is proposed that the operating medium pressure system has at least one throttle which is connected to the cooling duct and the electric motor in terms of flow, and which is provided for reducing a flow rate of coolant into the electric motor. A defined flow rate of coolant to the electric motor may thus be supplied in a particularly simple manner. “Throttle” is understood in particular to mean an element which has a tapered flow cross section at one end.

Further advantages result from the following description of the drawings. Three exemplary embodiments of the invention are illustrated in the drawings. The drawings, the description, and the claims contain numerous features in combination. Those skilled in the art will also advantageously consider the features individually and combine them into further meaningful combinations.

### BRIEF DESCRIPTION OF THE DRAWINGS

FIG. 1 schematically shows a hybrid drive train having a hybrid motor vehicle device.

FIG. 2 schematically shows an adjustment unit of the hybrid motor vehicle device,

FIG. 3 schematically shows a second exemplary embodiment of an adjustment unit, and

FIG. 4 schematically shows a third exemplary embodiment of an adjustment unit.

### DESCRIPTION OF EXEMPLARY EMBODIMENTS

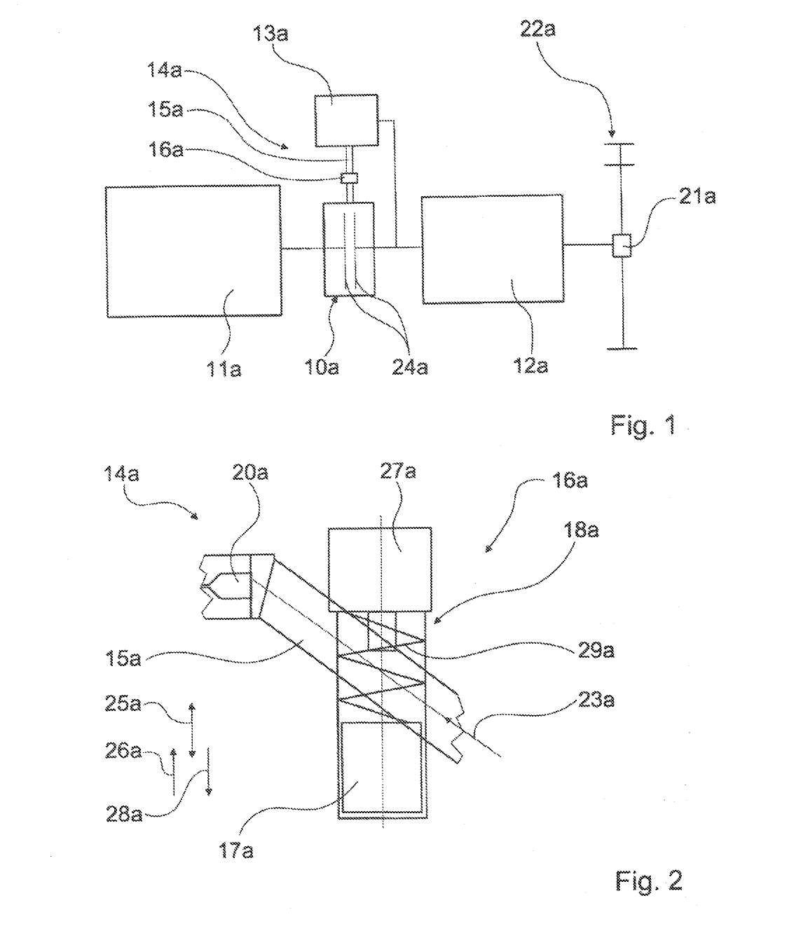

FIGS. 1 and 2 schematically show a hybrid drive train of a hybrid motor vehicle having a hybrid motor drive arrangement.. The hybrid motor drive arrangement includes a wet-running starting element 10a which connects an internal combustion engine 11a of the hybrid drive train to a transmission unit 12a of the hybrid drive train, which is coupled to drive wheels 22a of the hybrid motor vehicle via a differential 21a. The starting element 10a is in the form of a fluid-cooled starting element. The starting element is cooled, lubricated, and activated by means of an operating medium. The starting element 10a is a multi-plate clutch, In principle, the starting element may also be a different starting element which appears meaningful to those skilled in the art, such as a torque converter. The operating medium is provided as an oil,

For the alternative or joint generation of propulsion power of the hybrid motor vehicle, the hybrid motor drive arrangement includes an electric motor 13a which is connected to the transmission unit 12a. For cooling and lubricating the starting element 10a and for cooling the electric motor 13a, the hybrid motor drive arrangement includes an operating medium pressure system 14a, having a cooling duct 15a which in at least one operating state connects the starting element 10a and the electric motor 13a to one another fluidically. The cooling duct 15a is designed as a coolant supply duct which conducts an operating medium, which is provided as a coolant, from an operating medium chamber of the starting element 10a into the electric motor 13a. The cooling duct is provided for cooling the electric motor 13a. The cooling duct 15a provides for fluid communication between the operating medium chamber of the starting element 10a and an operating medium chamber in the form of a coolant chamber of the electric motor 13a in which an element of the electric motor 13a to be cooled, for example a rotor support and/or a rotor of the electric motor 13a, is situated. The operating medium pressure system 14a is designed as a cooling and lubricating pressure system.

The cooling duct 15a is formed, i.e., defined or enclosed, by a material of the starting element 10a and by a material of the electric motor 13a. In principle, the cooling duct 15a may also be formed by a hole, for example in a separating element between the operating medium chamber of the starting element 10a and the operating medium chamber of the electric motor 13a. It is also conceivable for the cooling duct 15a to be formed in whole or in part by a material which is separate from the starting element 10a and/or from the electric motor 13a.

For reducing a flow rate of the coolant into the electric motor 13a, the operating medium pressure system 14a has a throttle 20a which is connected to the cooling duct 15a and the electric motor 13a in terms of flow. The throttle regulates the flow rate of the coolant into the coolant chamber of the electric motor 13a. The throttle 20a connects the cooling duct 15a to the coolant chamber of the electric motor 13a in terms of flow, and is situated behind the cooling duct 15a with respect to a direction of flow 23a of the coolant, The throttle 20a has a restricted cross section which restricts the flow to the coolant chamber of the electric motor 13a, and which forms a coolant outlet.

For cooling the electric motor 13a as needed, the operating medium pressure system 14a has an adjustment unit 16a which varies a flow cross section of the cooling duct 15a. The adjustment unit 16a is designed as a mechanical adjustment unit, and varies the flow cross section automatically, i.e., without an external force and/or without electronic control and regulation. The adjustment unit 16a is situated in the cooling duct 15a between the operating medium chamber of the starting element 10a and the coolant chamber of the electric motor 13a.

The adjustment unit 16a varies the flow cross section of the cooling duct 15a as a function of an operating state of the starting element 10a. The adjustment unit varies the flow cross section as a function of a rotational speed of the internal combustion engine 11a. The adjustment unit 16a has a blocking element 17a which closes the cooling duct 15a in an activated state of the starting element 10a, and opens the cooling duct 15a in a deactivated state of the starting element 10a. Thus, the starting element 10a is closed in the activated state and open in the deactivated state. The blocking element 17a doses the cooling duct 15a above an idle speed of the internal combustion engine 11a, and opens the cooling duct 15a at and blow the idle speed of the internal combustion engine 11a. In the present exemplary embodiment, the idle speed is approximately 500 revolutions per minute. The adjustment unit 16a closes the cooling duct 15a by means of the blocking element 17a when the operating medium is used in the starting element 10a, and opens the cooling duct 15a by means of the blocking element 17a when the operating medium is not needed in the starting element 10a. In principle, the blocking element 17a may be provided for closing the cooling duct 15a for an active, i.e. running, internal combustion engine 11a, and for opening the cooling duct for an inactive internal combustion engine 11a that is when the internal combustion engine is shut down.

The blocking element 17a blocks or unblocks the cooling duct 15a. The blocking element 17a is radially situated with respect to the starting element 10a, i.e., with respect to rotating elements 24a of the starting element 10a. The blocking element is situated so as to be movable in a radial direction 25a relative to the rotating elements 24a. The radial direction 25a is perpendicular or partially perpendicular to a rotational axis of the starting element 10a, i.e., oriented perpendicularly with respect to a rotational axis of the rotating elements 24a of the starting element 10a. The rotating elements 24a are in the form of plates. The blocking element 17a varies the flow cross section of the cooling duct 15a as a function of a centrifugal force in the starting element 10a. The blocking element 17a is moved in the radial direction 25a by the centrifugal force, as a result of which the blocking element 17a closes or opens the cooling duct 15a. The centrifugal force acts radially outwardly, i.e., in a radial direction 26 pointing away from the rotational axis. The adjustment unit 16a is situated radially above the rotational axis, and is situated above the rotational axis with respect to the radial direction 25a. In FIG. 2, the rotational axis of the starting element 10a is situated beneath [the plane of the drawing in] FIG. 2. The adjustment unit 16a thus forms a centrifugal force regulator. The blocking element 17a is designed as a valve piston, and is situated within the starting element 10a.

The adjustment unit 16a also includes a restoring element 18a and a closure element 27a. The closure element 27a is provided for partially engaging with the blocking element 17a in order to tightly close the cooling duct 15a. The closure element is immovable, and thus fixedly mounted. The closure element 27a is situated after the blocking element 17a along the radial direction 26a, and is situated farther radial outwardly than the blocking element 17a. The closure element 27a is designed as a screw plug. The restoring element 18a automatically opens the cooling duct 15a as a function of a force in the starting element 10a, and automatically unblocks the cooling duct 15a as a function of the force in the starting element 10a. The force in the starting element 10a is provided as the centrifugal force. The restoring element 18a has a restoring force which acts against the force in the starting element 10a, which is provided as centrifugal force. The restoring force of the restoring element 18a has a direction of action 28a which points radially inwardly. The direction of action 28a is oriented parallel to and in the opposite direction of the radial direction 26a. The restoring element 18a pushes the blocking element 17a away from the closure element 27a, and seeks to open the cooling duct 15a by means of the restoring force.

The restoring element 18a has a restoring spring 29a which provides the restoring force. The restoring spring 29a is situated between the blocking element 17a and the closure element 27a in terms of action. At one end the restoring spring is fixedly connected to the blocking element 17a, and at the other, opposite end is fixedly connected to the closure element 27a. The restoring force of the restoring element 18a is provided as an elastic force.

In an operating state in which the propulsion power of the hybrid motor vehicle is provided by the electric motor 13a, and thus using solely the electric motor of the hybrid motor vehicle during travel, the starting element 10a has a rotational speed of zero, so that centrifugal force is also not present in the starting element 10a. The restoring element 18a pushes the blocking element 17a radially inwardly, and due to the lack of centrifugal force moves the blocking element 17a in a direction opposite from the radial direction 26a, and thus automatically unblocks the cooling duct 15a. The adjustment unit 16a thus varies the flow cross section of the cooling duct 15a to a maximum value, and thus opens the cooling duct 15a, so that the operating medium, which is provided as coolant and lubricant, is conducted from the starting element 10a as coolant to the electric motor 13a. The throttle 20a is designed in such a way that sufficient coolant is present for the electric motor 13a for an operating medium pressure (lubrication pressure) in the starting element 10a when the internal combustion engine 11a is stationary, and thus during travel using solely the electric motor.

In an operating state in which the propulsion power of the hybrid motor vehicle is provided by the internal combustion engine 11a, and thus during travel using solely the internal combustion engine of the hybrid motor vehicle, the starting element 10a has a rotational speed that is greater than the idle speed of the internal combustion engine 11a, so that a centrifugal force is also present in the starting element 10a which is greater than the restoring force of the restoring element 18a. The centrifugal force pushes the blocking element 17a radially outwardly against the restoring force, and moves the blocking element 17a in the radial direction 26a, so that the blocking element 17a blocks the cooling duct 15a. The adjustment unit 16a thus varies the flow cross section of the cooling duct 15a to a minimum value of zero and thus closes the cooling duct 15a, so that flow of operating medium from the starting element 10a into the electric motor 13a is prevented.

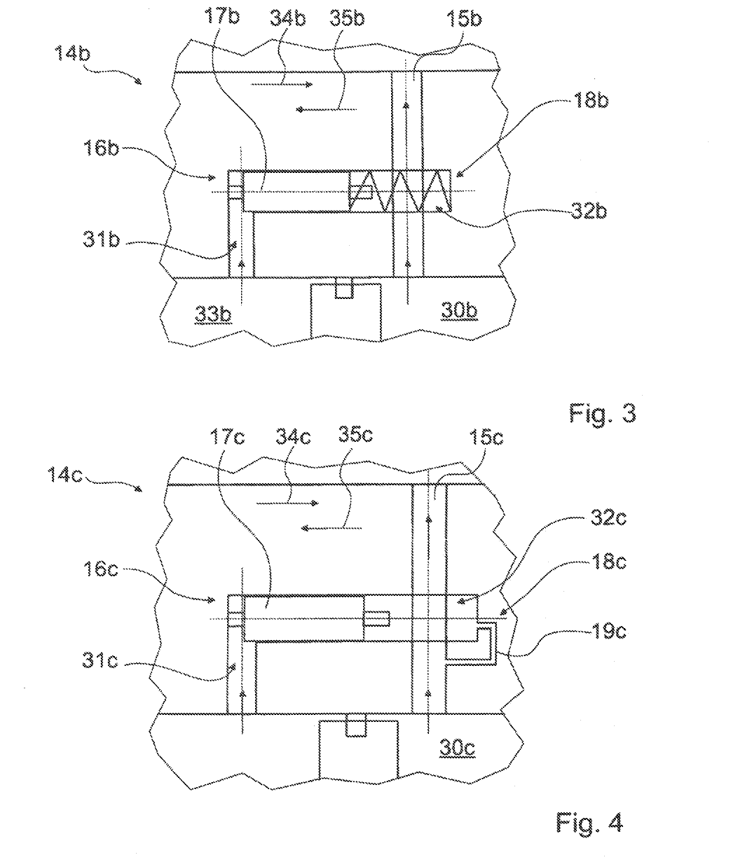

FIGS. 3 and 4 show two further exemplary embodiments of the invention. The following description is limited essentially to the differences between the exemplary embodiments, whereby with regard to components, features and functions which remain unchanged, reference may be made to the description of the other exemplary embodiments, in particular in FIGS. 1 and 2. To differentiate the exemplary embodiments, the letter “a” in the reference numerals of the exemplary embodiment in FIGS. 1 and 2 is replaced by the letters “b” and “c” in the reference numerals of the exemplary embodiments in FIGS. 3 and 4, respectively. With regard to components which are denoted in the same way, in particular components having the same reference numerals, reference may basically be made to the drawings and/or the description of the other exemplary embodiments, in particular in FIGS. 1 and 2.

FIG. 3 schematically illustrates an alternative design of an adjustment unit 16b of an operating medium pressure system 14b of a hybrid motor vehicle device. In contrast to the preceding exemplary embodiment, the adjustment unit 16b has a blocking element 17b which varies a flow cross section of a cooling duct 15b as a function of an operating medium pressure, provided as an activation pressure, in a starting element. The cooling duct 15b is connected to an operating medium chamber, designed as a coolant and lubricant chamber 30b, of the starting element 10a in terms of flow. The adjustment unit 16b forms a pressure regulator.

The adjustment unit 16b has a first chamber 31b and a second chamber 32b, between which the blocking element 17b is situated and seals the first chamber and second chamber from one another. The first chamber 31b is connected to an operating medium chamber, designed as an activating medium chamber 33b, of the starting element in terms of flow. The adjustment unit 16b also includes a restoring element 18b, which is situated in the second chamber 32b. At one end the adjustment unit is fixedly connected to the blocking element 17b. The restoring element 18b has a restoring force which acts against an activation pressure in the first chamber 31b. The restoring element 18b automatically opens the cooling duct 15b as a function of a force, formed by the activation pressure, in the starting element. The activation pressure in the first chamber 31b and the restoring force in the second chamber 32b work against one another, so that the blocking element 17b is correspondingly moved and the cooling duct 15b is blocked or unblocked. The restoring element 18b pushes the blocking element 17b against the activation pressure in the first chamber 31b.

As the result of controlling the starting element, the activation pressure in the activating medium chamber 33b of the starting element, and therefore the operating medium pressure in the first chamber 31b of the adjustment unit 16b, increases. When the operating medium pressure, provided as activation pressure, in the first chamber 31b increases above the oppositely acting restoring force of the restoring element 18b, the operating medium pressure in the first chamber 31b pushes the blocking element 17b in a direction 34b pointing toward the cooling duct 15b, so that the blocking element 17b closes the cooling duct 15b in terms of flow. When the operating medium pressure, provided as activation pressure, in the first chamber 31b falls below the restoring force, the restoring element 18b pushes the blocking element 17b in a direction 35b opposite from direction 34b and blocks the cooling duct 15b, so that the adjustment unit 16b once again opens the cooling duct 15b and connects the coolant and lubricant chamber 30b to an electric motor in terms of flow.

FIG. 4 schematically illustrates a third exemplary embodiment of an adjustment unit 16c of an operating medium pressure system 14c of a hybrid motor vehicle device. In contrast to the preceding exemplary embodiment according to FIG. 3, the adjustment unit 16c varies a flow cross section of a cooling duct 15c as a function of an operating medium pressure provided as activation pressure, and as a function of an operating medium pressure, provided as cooling and lubricating pressure, in a starting element.

The adjustment unit 16c has a restoring element 18c which includes a control pressure duct 19c. The control pressure duct 19c connects in terms of flow a second chamber 32c of the adjustment unit 16c to the cooling duct 15c, which is connected to a coolant and lubricant chamber 30c. An operating medium pressure, provided as the cooling and lubricating pressure, in the second chamber 32c acts against an operating medium pressure, provided as the activation pressure, in a first chamber 31c, so that the blocking element 17c is correspondingly moved and the cooling duct 15c is blocked or unblocked. The restoring element 18c automatically opens the cooling duct 15c as a function of a force provided as the activation pressure, and as a function of a force, provided as the cooling and lubricating pressure, in the starting element. A restoring force of the restoring element 18c is provided as an operating medium pressure. The restoring force is provided as a cooling and lubricating pressure in the coolant and lubricant chamber 30c of the starting element. In principle, the restoring element 18c may additionally have a restoring spring.

As the result of controlling the starting element, the activation pressure in the starting element, and therefore the operating medium pressure in the first chamber 31c, increases. When the operating medium pressure, provided as activation pressure, in the first chamber 31c increases above the oppositely acting operating medium pressure, provided as cooling and lubricating pressure, in the second chamber 32c, the operating medium pressure in the first chamber 31c pushes the blocking element 17c in a direction 34c, so that the blocking element 17c closes the cooling duct 15c in terms of flow. When the operating medium pressure, provided as activation pressure, in the first chamber 31c falls below the operating medium pressure provided as cooling and lubricating pressure in the second chamber 32c, the operating medium pressure, provided as cooling and lubricating pressure, in the second chamber 32c pushes the blocking element 17c in a direction 35c, so that the adjustment unit 16c once again opens the cooling duct 15c.

What is claimed is:

1. A hybrid motor vehicle device, comprising an internal combustion engine (11a) a transmission unit (12a) connected to the internal combustion engine and including, at least one electric motor (13a) which is provided for connection to the transmission unit (12a), a starting element (10a) connected to the internal combustion engine (11a) and having an operating medium pressure system (14a, 14b; 14c) for at least cooling the electric motor (13a) and the starting element (10a), and including at least one cooling duct (15al 15b; 15c) which, in at least one operating state, places the starting element (10a) and the electric motor (13a) in fluid communication with one another, the operating medium pressure system (14a; 14b; 14c) having at least one adjustment unit (16a; 16b; 16c) for varying a flow cross section of the cooling duct (15a; 15b; 15c) for controlling the coolant flow to the electric motor (13a) in the at least one operating state.

2. The hybrid motor vehicle device according to claim 1, wherein the adjustment unit (16a; 16b; 16c) is provided for varying the flow cross section of the cooling duct (15a; 15b; 15c) as a function of an operating state of the starting element (10a).

3. The hybrid motor vehicle device according to claim 2, wherein the adjustment unit (16a; 16b; 16c) has at least one blocking element (17a; 17b; 17c) which is provided for closing the cooling duct (15a; 15b; 15c) in an activated state of the starting element (10a), and for opening the cooling duct in a deactivated state of the starting element (10a).

4. The hybrid motor vehicle device according to claim 3, wherein the blocking element (17a; 17b; 17c) is provided for varying the flow cross section of the cooling duct (15a; 15b; 15c) as a function of a centrifugal force generated in the starting element (10a) when the internal combustion engine is operated at a speed exceeding idle speed.

5. The hybrid motor vehicle device according to claim 3, wherein the blocking element (17a; 17b; 17c) is provided for varying the flow cross section of the cooling duct (15a; 15b; 15c) as a function of an operating medium pressure in the starting element (10a).

6. The hybrid motor vehicle device according to claim 3, wherein the blocking element (17a; 17b; 17c) is in the form of a valve piston.

7. The hybrid motor vehicle device according to claim 3, wherein the adjustment unit (16a; 16b; 16c) includes restoring element (18a; 18b; 18c) which is provided for automatically opening the cooling duct (15a; 15b; 15c) as a function of a force generated in the starting element (10a).

8. The hybrid motor vehicle device according to claim 7, wherein the restoring element (18c) includes a control pressure duct (19c).

9. The hybrid motor vehicle device according to claim 1, wherein the cooling duct (15a; 15b; 15c) is a coolant supply duct which is provided for conducting a coolant from an operating medium chamber of the starting element (10a) to the electric motor (13a).

10. The hybrid motor vehicle device according to claim 1, wherein the operating medium pressure system (14a; 14b; 14c) has at least one throttle (20a) which is connected to the cooling duct (15a; 15b; 15c) and to the electric motor (13a) in terms of flow, and which is provided for controlling a flow rate of the coolant to the electric motor (13a).
